(19) United States
(12) Patent Application Publication
(10) Pub. No.: US 2026/0017967 A1
(43) Pub. Date: Jan. 15, 2026

(54) OCR METHOD AND SYSTEM BASED ON CHARACTER-WISE SUPERVISED CONTRASTIVE LEARNING MODEL

(71) Applicant: NAVER CORPORATION, Seongnam-si (KR)

(72) Inventors: Daehee KIM, Seongnam-si (KR); Yoonsik KIM, Seongnam-si (KR); Yumin LIM, Seongnam-si (KR); Donghyun KIM, Seongnam-si (KR); Geewook KIM, Seongnam-si (KR); Taeho KIL, Seongnam-si (KR)

(21) Appl. No.: 19/335,051

(22) Filed: Sep. 22, 2025

Related U.S. Application Data
(63) Continuation of application No. PCT/KR2024/003483, filed on Mar. 20, 2024.

(30) Foreign Application Priority Data
Mar. 23, 2023 (KR) 10-2023-0037945

(51) Int. Cl. G06V 30/19; G06V 10/774

(52) U.S. Cl. CPC G06V 30/19147; G06V 10/774

(57) ABSTRACT

An OCR method using a character-wise supervised contrastive learning model includes receiving an input image; extracting, from the input image, a token sequence representing character information and location information of the input image by means of a character-wise supervised contrastive learning model; and converting the token sequence into visualized information.

### CROSS-REFERENCE TO RELATED APPLICATIONS

This is a continuation application of International Application No. PCT/KR2024/003483, filed Mar. 20, 2024, which claims the benefit of Korean Patent Application No. 10-2023-0037945, filed Mar. 23, 2023.

### BACKGROUND OF THE INVENTION

### Field of the Invention

The present disclosure relates to an OCR method and a system based on a character-wise supervised contrastive learning model and, more specifically, to a character-wise supervised contrastive learning method using learning data including an image, character information, and its associated location information, and to a method and a system capable of performing OCR using a deep learning model trained by this learning method.

### Description of Related Art

Contrastive learning is a machine learning method aimed at learning useful representations from data by bringing similar training data pairs closer together and pushing dissimilar training data pairs further apart. Contrastive learning has been applied successfully to tasks such as image classification and object detection, making it a popular learning method in computer vision.

Since a diversity of similar training data pairs is required for effective contrastive learning, data augmentation is used to increase the amount of training data. For example, data augmentation techniques are often used to generate similar images by applying various transformations to images, such as randomly cropping an image and flipping an image left/right and/or up/down.

There are several issues with applying contrastive learning to the training of Optical Character Recognition (OCR) systems. Since input images for OCR systems contain characters, data augmentation techniques commonly used in contrastive learning can lead to problems such as loss of characters or alteration of character features. Another problem is that loss functions typically used in contrastive learning are not appropriate for training aimed at improving the accuracy of character recognition in OCR systems.

### BRIEF SUMMARY OF THE INVENTION

In order to address the foregoing problems, the present disclosure describes a character-wise supervised contrastive learning method, an OCR method based on a deep learning model trained by this learning method, and a computer-readable, non-transitory recording medium and apparatus (system) with instructions recorded thereon.

The present invention may be implemented in various ways, including a method, an apparatus (system), or a computer-readable, non-transitory recording medium with instructions recorded thereon.

According to one embodiment of the present invention, there is provided an OCR method using a character-wise supervised contrastive learning model, which is performed by at least one processor of a computing device, the OCR method comprising the steps of: receiving an input image; extracting, from the input image, a token sequence representing character information and location information of the input image by means of a character-wise supervised contrastive learning model; and converting the token sequence into visualized information.

According to one embodiment of the present invention, there is provided a character-wise supervised contrastive learning method for OCR, which is performed by at least one processor of a computing device, the method comprising the steps of: receiving first training data including a first image and first character information; receiving second training data including a second image, second character information corresponding to the first character information, and location information associated with the second character information; and training a deep learning-based encoder-decoder model to output a token sequence representing character information and location information for an input image, by using the first training data and the second training data.

There is provided a computer-readable non-transitory recording medium having instructions recorded thereon for executing an OCR method using a character-wise supervised contrastive learning model according to one embodiment of the present invention.

According to one embodiment of the present invention, there is provided an OCR system using a character-wise supervised contrastive learning model, the OCR system comprising: a memory; and at least one processor connected to the memory, and configured to run at least one computer-readable program stored in the memory, wherein the at least one program receives an input image, extracts, from the input image, a token sequence representing character information and location information of the input image by means of a character-wise supervised contrastive learning model, and includes one or more instructions for converting the token sequence into visualized information.

According to some embodiments of the present invention, it is possible to improve the accuracy of character recognition in an OCR system by using a deep learning model generated through a character-wise contrastive learning method.

According to some embodiments of the present invention, the OCR system can effectively learn diverse features of character images, by generating a synthetic image containing characters with varying appearances, such as various fonts, sizes, thicknesses, and colors, and using it as training data.

According to some embodiments of the present invention, when there is not enough training data for supervised learning for OCR, a synthetic image containing location information of characters can be generated based on a real image which does not contain location information of characters and be used as training data, thereby enabling supervised learning for OCR.

The effects of the present invention are not limited to those mentioned above, and other effects not mentioned may be clearly understood by those skilled in the art to which this disclosure pertains from the description of the claims.

### BRIEF DESCRIPTION OF THE DRAWINGS

Embodiments of the present invention will be described with reference to the accompanying drawings described below, in which similar reference symbols indicate similar elements but without being limited thereto.

FIG. 1 is a schematic diagram illustrating an example of an OCR system using a character-wise contrastive learning model according to an embodiment of the present invention.

FIG. 2 is a block diagram illustrating an internal configuration of a computing device according to an embodiment of the present invention.

FIG. 3 is a block diagram illustrating an internal configuration of a processor of the computing device according to an embodiment of the present invention.

FIG. 4 is a block diagram illustrating a configuration example of a deep learning model according to an embodiment of the present invention.

FIG. 5 is a diagram illustrating an example of a synthetic document generation method for character-wise supervised contrastive learning according to an embodiment of the present invention.

FIG. 6 is a diagram illustrating an example of a character-wise supervised contrastive learning method according to an embodiment of the present invention.

FIG. 7 is a diagram illustrating examples of feature clustering results from a deep learning model trained by various training methods.

FIG. 8 is a flowchart illustrating an example of an OCR method using a character-wise supervised contrastive learning model according to an embodiment of the present invention.

FIG. 9 is a flowchart illustrating an example of a character-wise supervised contrastive learning method for OCR according to an embodiment of the present invention.

### DETAILED DESCRIPTION OF THE INVENTION

Hereinafter, specific details for carrying out the present invention will be described in detail with reference to the accompanying drawings. However, in the following description, detailed descriptions of well-known functions or configurations will be omitted if there is a risk of unnecessarily obscuring the gist of the present invention.

In the accompanying drawings, identical or corresponding elements are 1 embodiments, repeated descriptions of identical or corresponding components may be omitted. However, even if a description of a specific component is omitted, it is not intended that such a component not be included in a corresponding embodiment.

Advantages and features of the disclosed embodiments and methods for achieving them will become clear by referring to the embodiments described below in conjunction with the accompanying drawings. However, the present invention is not limited to the embodiments disclosed below and may be implemented in various different forms, and these embodiments are provided only to make the disclosure complete and fully inform those skilled in the art of the scope of the invention.

Terms used in this specification will be briefly described, and the disclosed embodiments will be described in detail. The terms used in this specification are selected as being general terms currently widely used as much as possible while considering their functions in the present disclosure, but they may vary depending on the intentions of engineers working in the related fields, precedents, the emergence of new technologies, or the like. Additionally, there may be terms deliberately selected by the applicants, and in such a case, their meanings will be described in detail in the description of the relevant invention. Accordingly, the terms used in this disclosure should be defined based on the meanings of the terms and the overall content of the present disclosure, rather than simply the names of the terms.

In this specification, singular expressions include plural expressions, unless the context clearly indicates otherwise. Also, plural expressions include singular expressions, unless the context clearly indicates otherwise. In the entire specification, when a part includes a specific component, this means that other components may be further included rather than excluding other components unless expressly stated to the contrary.

In addition, the term “module” or “unit” used in the specification refers to a software or hardware component, and the “module” or “unit” performs specific roles. However, the “module” or “unit” is not limited to software or hardware. A “module” or “unit” may be configured to reside on an addressable storage medium and may be configured to run one or more processors. Thus, as an example, a “module” or “unit” may include at least one of components such as software components, object-oriented software components, class components and task components, processes, functions, properties, procedures, subroutines, program code segments, drivers, firmware, microcode, circuits, data, databases, data structures, tables, arrays, or variables. The functionality provided within components and “modules” or “parts” may be combined into fewer components and “modules” or “units,” or may be further divided into additional components and “modules” or “units”.

According to an embodiment of the present invention, a “module” or “unit” may be implemented with a processor and a memory. The term “processor” should be interpreted broadly to include a central processing unit (CPU), a microprocessor, a digital signal processor (DSP), a controller, a microcontroller, a state machine, and the like. In some contexts, a “processor” may refer to an application-specific integrated circuit (ASIC), a programmable logic device (PLD), a field programmable gate array (FPGA), or the like. A “processor” may refer to, for example, a combination of a DSP and a microprocessor, a combination of a plurality of microprocessors, a combination of one or more microprocessors coupled with a DSP core, or a combination of other processing devices. In addition, the term “memory” should be interpreted broadly to include any electronic component capable of storing electronic information. A “memory” may refer to various types of processor-readable media such as random access memory (RAM), read-only memory (ROM), non-volatile random access memory (NVRAM), programmable read-only memory (PROM), erasable-programmable read only memory (EPROM), electrically erasable PROM (EEPROM), flash memory, magnetic or optical data storage, and registers. A memory is said to be in electronic communication with a processor if the processor can read information from the memory and/or write information to the memory. The memory integrated into a processor is in electronic communication with the processor.

In the present disclosure, the term “system” may include, but not limited to, at least one of a server device and a cloud device. For example, a system may be composed of one or more server devices. As another example, a system may be composed of one or more cloud devices. As another example, a system may operate by being composed of a server device and a cloud device together.

In the present disclosure, the term “deep-learning model” may refer to a machine learning algorithm or model capable of performing high-level abstraction through a combination of multiple or a plurality of nonlinear transformation techniques or models. A deep learning model may be implemented as a deep neural network capable of modeling complex nonlinear relationships, wherein the deep neural network may represent an artificial neural network that includes a plurality of hidden layers between an input layer and an output layer.

In the present disclosure, the term “document image” may include an electronic file containing a document, a scanned image of a document, or a photographed image of a document.

In the present disclosure, the expressions “each of a plurality of A” or “a plurality of A each” may refer to each of all components included in the plurality of A or may refer to each of some components included in the plurality of A.

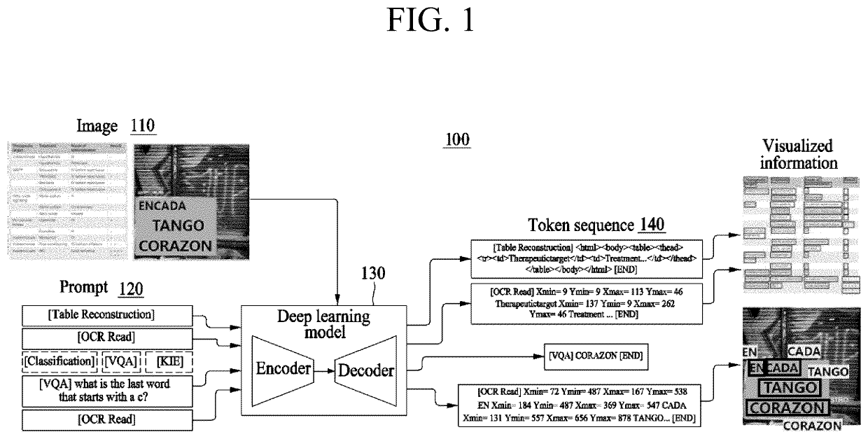

FIG. 1 is a schematic diagram illustrating an example of an OCR system 100 using a character-wise contrastive learning model according to an embodiment of the present invention. The OCR system 100 may extract a token sequence 140 representing character information and its associated location information from an image 110 by using a deep learning model 130, and may convert the extracted token sequence 140 into visualized information.

For example, the OCR system 100 may first receive an image 110. Here, the image may include a document image and/or a scene image containing characters.

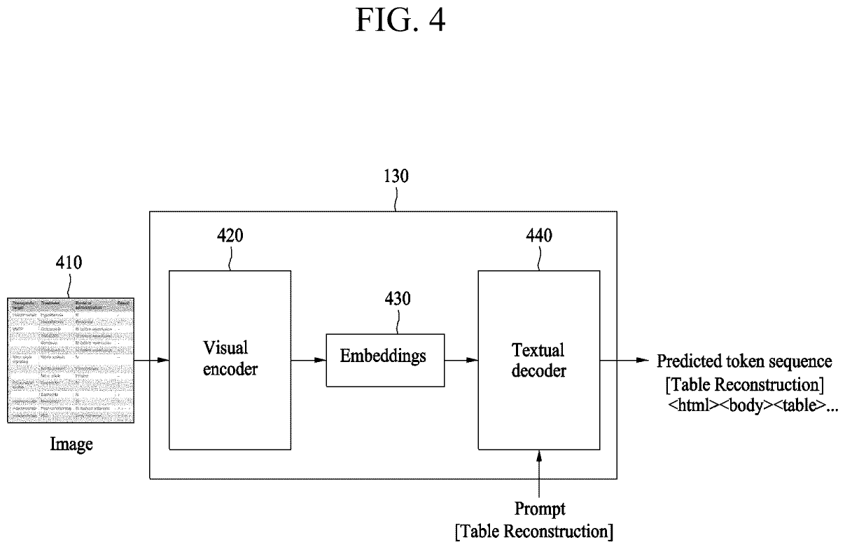

Then, the OCR system 100 may feed the image 110 as an input into the deep learning model 130 to output a token sequence 140. Here, the deep learning model 130 may be a deep learning-based encoder-decoder model. For example, the encoder included in the deep learning model 130 may extract embeddings representing features of the image from the image 110, and the decoder included in the deep learning model 130 may extract the token sequence 140 based on the embeddings extracted by the encoder. The structure of the deep-learning model 130 will be described in detail with reference to FIG. 4.

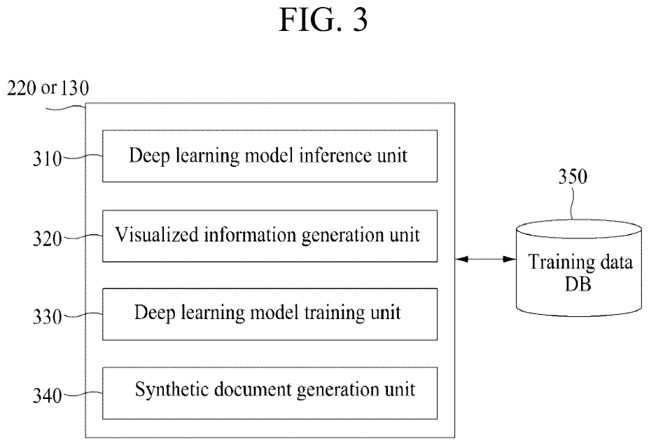

According to one embodiment, the deep learning model 130 may be a model trained to perform an OCR operation for extracting a token sequence 140 representing character information and location information of the input image 110 from the input image 110. For example, the deep learning model 130 may be a mode trained through a character-wise contrastive learning method to improve the accuracy of character recognition. A learning method for the deep learning model 130 will be described in more detail with reference to FIGS. 3, 5, and 6.

The deep learning model 130 trained to extract a token sequence 140 representing character information and location information may output a token sequence 140 representing character information and location information from the input image 110. For example, the token sequence 140 may include a sequence of word instances contained in the input image 110, and the sequence of word instances may include location information (e.g., four coordinate tokens (Xmin, Ymin, Xmax, and Ymax)) and character information (e.g., one or more word tokens).

According to one embodiment, the deep learning model 130 may be fine-tuned to perform various downstream tasks from the input image 110 based on various user prompts 120. In response to a user prompt 120 indicating the type of an OCR operation, the deep learning model 130 may output a token sequence 140 from the input image 110.

For example, the deep learning model 130 may perform parsing of a document image and output a token sequence 140 representing a parsing result, in response to a user prompt 120 (e.g., “[Table Reconstruction]”) requesting parsing (e.g., table structuring) of the document image.

As another example, the deep learning model 130 may output a token sequence 140 representing a classification result of a document image, in response to a user prompt 120 (e.g., “[Classification]”) requesting classification of the document image.

As yet another example, the deep learning model 130 may output a token sequence 140 (e.g., ‘[VQA]CORAZON[END]’) representing an answer to a question, in response to a user prompt 120 (e.g., ‘[VQA] What is the last word that starts with a c?’) requesting visual question answering for a scene image containing characters.

Additionally, the OCR system 100 may convert the token sequence 140 output by the deep learning model 130 into visualized information. For example, the visualized information may be a layer added on top of the input image, including character information contained in the input image and/or location information (e.g., a bounding box) corresponding to the character information. A bounding box may be a rectangular or other geometric border used in digital image processing to enclose an object of interest. It defines the object's location and extents by providing the coordinates of its corners (e.g., top-left and bottom-right).

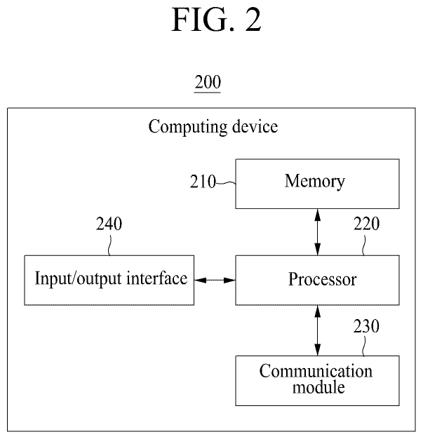

FIG. 2 is a block diagram illustrating an internal configuration of a computing device 200 according to an embodiment of the present invention. The computing device 200 may include a memory 210, a processor 220, a communication module 230, and an input/output interface 240. As illustrated in FIG. 2, the computing device 200 may be configured to communicate information and/or data over a network using the communication module 230.

The memory 210 may include any non-transitory computer-readable recording medium. According to one embodiment, the memory 210 may include a permanent mass storage device such as random-access memory (RAM), read-only memory (ROM), a disk drive, a solid-state drive (SSD), and flash memory. In another example, a permanent mass storage device such as ROM, SSD, flash memory, and a disk drive may be included in the computing device 200 as a separate permanent storage unit which is distinct from the memory 210. Additionally, the memory 210 may store an operating system and at least one program code (e.g., code for character-wise supervised contrastive learning or OCR using a character-wise supervised contrastive learning model, installed and run on the computing device 200).

These software components may be loaded from a computer-readable recording medium separate from the memory 210. Such a separate computer-readable recording medium may include recording media directly connectable to the computing device 200, such as a floppy drive, a disk, tape, a DVD/CD-ROM drive, and a memory card. In another example, software components may be loaded onto the memory 210 through a communication module 230 rather than a computer-readable recording medium. For example, at least one program may be loaded onto the memory 210 based on a computer program (e.g., a program for character-wise supervised contrastive learning or OCR using a character-wise supervised contrastive learning model) installed by files provided through the communication module 230 by developers or a file distribution system that distributes installation files for applications.

The processor 220 may be configured to process instructions of a computer program by performing basic arithmetic, logic, and input/output operations. The instructions may be provided to a user terminal (not shown) or another external system by the memory 210 or the communication module 230. For example, the processor 220 may train a deep learning-based encoder-decoder model to output a token sequence representing character information and location information for an input image, by using first training data and second training data. Additionally, the processor 220 may use the trained deep-learning-based encoder-decoder model to extract a token sequence representing character information and location information for an input image from the input image.

The communication module 230 may provide a configuration or function for a user terminal (not shown) and the computing device 200 to communicate with each other via a network, and may provide a configuration or function for the computing device 200 to communicate with an external system (e.g., a separate cloud system). For example, control signals, commands, and data provided under the control of the processor 220 of the computing device 200 may be transmitted to the user terminal and/or the external system through the communication modules of the user terminal and/or external system via the communication module 230 and the network. For example, structured information extracted by the computing device 200 may be transmitted to the user terminal.

In addition, the input/output interface 240 of the computing device 200 may be a means for interfacing with an apparatus (not illustrated) for inputting or outputting data, which may be connected to the computing device 200 or included in the computing device 200. In FIG. 2, the input/output interface 240 is illustrated as, but not limited to, a component configured separately from the processor 220, but the input/output interface 240 may be configured to be included in the processor 220. The computing device 200 may include more components than those illustrated in FIG. 2. Related art components may not necessarily require exact illustration.

The processor 220 of the computing device 200 may be configured to manage, process, and/or store information and/or data received from a plurality of user terminals and/or a plurality of external systems. According to one embodiment, the processor 220 may receive an input image from a user terminal and/or an external system. In this case, the processor 220 may extract, from the image, a token sequence representing character information and location information of the input image by using a trained, character-wise supervised comparative learning model. In addition, the processor 220 may convert the token sequence into visualized information.

FIG. 3 is a diagram illustrating an internal configuration of the processor 220 of the computing device 200 according to an embodiment of the present invention. According to one embodiment, the processor 220 may include a deep learning model inference unit 310, a visualized information generation unit 320, a deep learning model training unit 330, and a synthetic document generation unit 340. The deep learning model 130 may include the deep learning model inference unit 310, the visualized information generation unit 320, the deep learning model training unit 330, and the synthetic document generation unit 340. In one embodiment, the processor 220 may receive an image, and the received image may be provided to the deep learning model inference unit 310, provided to the deep learning model training unit 330, or stored in a training data database (DB) 350, where it may be used for inference and/or training of the deep learning model 130.

The deep learning model inference unit 310 may output a token sequence based on an input image, by using the deep learning model 130. Here, the deep learning model 130 may be a deep learning-based encoder-decoder model.

First, the deep learning model inference unit 310 may extract embeddings from an input image by using the encoder. For example, the deep learning model inference unit 310 may convert the input image into embeddings, by using the encoder. According to one embodiment, the encoder may include a CNN (convolutional neural network)-based model or a transformer-based model. The embeddings extracted by the encoder may be provided to the decoder.

Furthermore, the deep learning model inference unit 310 may extract a token sequence from embeddings by using the decoder. For example, the deep learning model inference unit 310 may extract a token sequence from embeddings, by using the decoder. According to one embodiment, the decoder may be a transformer-based decoder such as BERT (Bidirectional Encoder Representations from Transformer) and BART (Bidirectional and Auto-Regressive Transformers).

According to one embodiment, the deep learning model inference unit 310 may additionally receive a user prompt as well as an input image, in which case, the deep learning model inference unit 310 may extract a token sequence based on the received user prompt and embeddings, by using the decoder. The deep learning model inference unit 310 may provide the token sequence extracted by the decoder to the visualized information generation unit 320. A concrete example in which a deep learning model 130 extracts a token sequence from an input image will be described in more detail with reference to FIG. 4.

The visualized information generation unit 320 may convert the token sequence provided from the deep learning model inference unit 310 into visualized information. For example, the visualized information generation unit 320 may generate visualized information by adding a new layer on top of the input image. Here, the new layer may include character information contained in the input image and/or location information (e.g., a bounding box) corresponding to the character information.

The deep learning model training unit 330 may perform training of a deep learning model 130 by using the training data stored in the training data DB 350.

The training data may include first training data, second training data paired with the first training data, and third training data. The first training data may include a real image (e.g., a document image and/or a scene image containing text) and character information associated with the real image. The second training data may include a synthetic image containing the same characters as the real image included in the first training data, character information, and location information associated with the character information. The second training data may be generated by the synthetic document generation unit 340 based on the first training data. The third training data may include an image, character information, and location information associated with the character information. Pairs of the first training data and the second training data may be used for contrastive learning.

The deep learning model training unit 330 may train the deep learning model 130 to output a token sequence representing character information and location information for the input image.

For example, the deep learning model training unit 330 may train the deep learning model 130 to output a token sequence representing character information and location information for the input image, by using the first training data and the second training data. The deep learning model training unit 330 may compute a loss function and train the deep learning model 130 such that the loss function is minimized. For example, the deep learning model training unit 330 may compute a first loss function that maximizes the probability of predicting the character information contained in the input image by using the real image as an input, and the probability of predicting the character information contained in the synthetic image and its associated location information by using the synthetic image as an input. Additionally or alternatively, the deep learning model training unit 330 may compute a second loss function representing a character-wise supervised contrastive loss, based on the first training data and the second training data. The total loss function may be computed based on the first loss function and/or the second loss function.

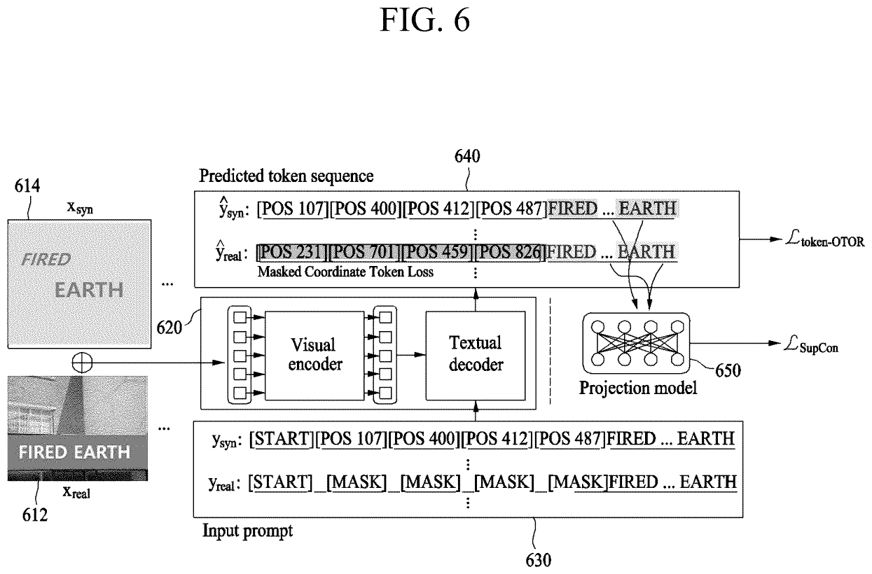

Additionally or alternatively, the deep learning model training unit 330 may train the deep learning model 130 to output a token sequence representing character information and location information for the input image, by using the third training data. An example of how the deep learning model training unit 330 trains the deep learning model will be described in more detail with reference to FIG. 6.

According to one embodiment, the training data may further include a user prompt indicating the type of an OCR operation. In this case, the deep learning model training unit 330 may train the deep learning model 130 to output a corresponding token sequence based on the input image and the user prompt.

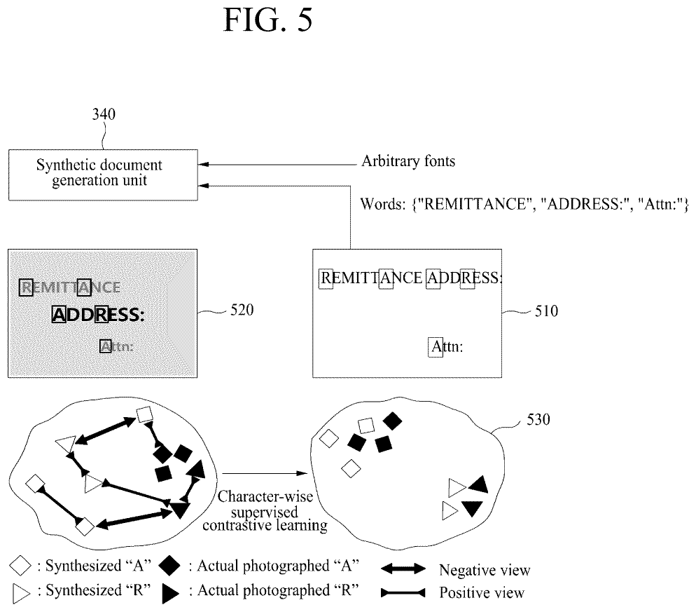

The synthetic document generation unit 340 may generate a synthetic document image for character-wise supervised contrastive learning. For example, the synthetic document generation unit 340 may generate a synthetic document image containing the same characters as the real image, based on character information (i.e., the character information contained in the real image), font information, and image background information. A concrete example of how the synthetic document generation unit 340 generates a synthetic document image will be described in more detail with reference to FIG. 5. The synthetic document image generated by the synthetic document generation unit 340 may be stored in the training data DB 350 and used by the deep learning model training unit 330 to train the deep learning model 130.

FIG. 4 is a diagram illustrating a configuration example of the deep learning model 130 according to an embodiment of the present invention. According to one embodiment, the deep learning model 130 may output a predicted token sequence based on an input image 410. Here, the deep learning model 130 may include a visual encoder 420 and a textual decoder 440.

The visual encoder 420 included in the deep learning model 130 may extract embeddings 430 from the input image 410. For example, the visual encoder 420 may transform the input image x∈R^{H×W×C} into the embeddings 430 v=Enc(x). Here, H, W, C may denote the height, width, and channel of the input image 410, respectively. In one embodiment, the visual encoder 420 may include either a CNN (convolutional neural network)-based model or a Transformer-based model.

The embeddings 430 (v) extracted by the visual encoder 420 may be provided to the textual decoder 440, and the textual decoder 440 may autoregressively predict a token sequence

$${( \hat{y} )}_{i = 1}^{N}$$

(where ŷₗ, is an i-th generated token, and N is the length of a token sequence generated by the decoder), from the embeddings 430 extracted by the visual encoder 420 and a given user prompt. For example, the textual decoder 440 may extract a token sequence “[Table Reconstruction] <html><body><table> . . . ” representing a parsing result based on the extracted embeddings 430, in response to a user prompt “[Table Reconstruction]” requesting structuring of a table contained in the image.

As another example, the textual decoder 440 may extract a token sequence

“[OCR Read] Xmin=72 Ymin=487 Xmax=167 Ymax=538 EN . . . ” representing a character recognition task result based on the extracted embeddings 430, in response to a user prompt “[OCR Read]” requesting an OCR operation on the image.

Here, the tokens enclosed in square brackets (“[ ]”), in the user prompt and the token sequence, may be special tokens, which may be tokens that the deep learning model 130 learned.

According to one embodiment, the textual decoder 440 may use a Transformer-based decoder.

The token sequence extracted by the textual decoder 440 may serve as the output of the deep learning model 130. According to one embodiment, the token sequence outputted by the deep learning model 130 may be then converted into visualized information.

FIG. 5 is a diagram illustrating an example of a synthetic document generation method for character-wise supervised contrastive learning according to an embodiment of the present invention. Conventionally, supervised contrastive learning is used primarily in image classification and, accordingly, training is performed mostly by using images or objects within images as instances. However, directly applying such a method to an OCR system does not effectively enhance character recognition accuracy. Therefore, according to one embodiment of the present invention, each character is treated as an instance, thereby enabling character-wise supervised contrastive learning.

Since a diversity of similar training data pairs is required for effective contrastive learning, data augmentation may be used to increase the amount of training data. For example, data augmentation techniques are often used to generate similar images by applying various transformations to images, such as randomly cropping an image and flipping an image left/right and/or up/down. However, since input images for OCR systems contain characters, data augmentation techniques commonly used in contrastive learning can lead to problems such as the loss of characters or the alterations of character features. Accordingly, according to one embodiment of the present invention, a synthetic image 520 for character-wise supervised contrastive learning may be generated.

According to one embodiment, the synthetic document generation unit 340 may generate a synthetic image 520 containing the same characters as the real image 510. For example, the synthetic document generation unit 340 may receive, as an input, a set of words contained in the real image 510 as character information, and generate a synthetic image 520 by rendering the words contained in the real image 510 on an arbitrary background color, with arbitrary fonts at arbitrary locations.

Additionally or alternatively, the synthetic document generation unit 340 may receive settings for generating a synthetic image 520 and generate a synthetic image 520 containing the same characters as the real image 510 in accordance with the received settings. For example, the synthetic document generation unit 340 may receive settings for background information (e.g., an RGB range of background color), font information (e.g., a list of font types, a font size range, and a font thickness range), and whether to generate character-wise coordinates, and may generate a synthetic image 520 containing the same characters as the real image 510 within the setting range.

Since the synthetic image 520 is directly generated by the synthetic document generation unit 340, it may include location information (e.g., coordinate information) associated with the character information contained in the synthetic image 520. Accordingly, even in cases where supervised learning for OCR is not possible since the real image 510 does not contain location information of characters, the synthetic image 520 generated by the synthetic document generation unit 340 contains the location information of the characters, thereby enabling supervised learning for OCR.

According to one embodiment, the OCR system 100 may perform training of the deep learning model 130 by using training data pairs of the real image 510 and the synthetic image 520 generated based on the real image 510. A loss function used for training the deep learning model 130 may include a character-wise supervised contrastive loss. By training the deep learning model 130 in such a way as to minimize the character-wise supervised contrastive loss, the model may be trained to extract similar features from identical characters and extract dissimilar features from different characters. That is, by performing training using the character-wise supervised contrastive loss, the deep learning model 130 may be trained such that feature pairs (e.g., A and A, R and R) extracted from identical characters are treated as positive views and are brought closer together within an embedding space 530 (e.g., a contrastive subspace), while feature pairs extracted from different characters (e.g., A and R) are treated as negative views and are pushed further apart within the embedding space 530. Concrete methods for training the deep learning model 130 and computing the supervised contrastive loss will be described in further detail with reference to FIG. 6.

Referring to the illustrated example, the character “A” in “ADDRESS” included in the real image 510 is not much different in appearance from the character “A” in “Attn” in the real image 510. The data augmentation methods used in the conventional art also tend to preserve the original appearance of characters with minimal variation. In contrast, it can be observed that the character “A” included in the synthetic image 520 generated by the synthetic document generation unit 340 was rendered with varying appearances (various fonts, sizes, thicknesses, colors, etc.). By using the synthetic images 520 in which characters are rendered with varying appearances, the deep learning model may effectively learn a diversity of features.

FIG. 6 is a diagram illustrating an example of a character-wise supervised contrastive learning method according to an embodiment of the present invention. The deep learning model training unit 330 may train a deep learning model 620 to output a token sequence 640 representing character information and location information for input images 612 and 614. The deep learning model 620 may correspond to the deep learning model 130.

For example, the deep learning model training unit 330 may train the deep learning model 620, by using a training image, character information contained in the training image, and location information associated with the character information. As a concrete example, the deep learning model 620 may be trained to predict target tokens including a prompt, coordinate tokens, and character tokens by using a loss function such as the one shown in Equation 1 below:

$${L}_{token} = - {\sum }_{i = 1}^{N} log P ( {y}_{i} \vert x , {\hat{y}}_{1 : i - 1} ) \qquad [ Equation 1 ]$$

where x denotes the input image, and

$${( {\hat{y}}_{i} )}_{i = 1}^{N}$$

denotes a token (where ŷᵢ is the i-th generated token, and N is the length of a token sequence generated by the decoder).

Additionally or alternatively, the deep learning model training unit 330 may train the deep learning model 620 using pairs of a real image 612 and a synthetic image 614 containing the same characters as the real image. For example, the deep learning model 620 may take the real image 612 and the synthetic image 614 containing the same characters as an input and autoregressively generate a token sequence 640, i.e., a token ŷᵢ=MLP(dᵢ), where dᵢ denotes the last hidden embedding of the decoder at i-th generation index. Also, the last hidden embedding dᵢ of the decoder may be fed into a projection model 650, and character-wise projections zᵢ=Proj(dᵢ) may be placed in a contrastive subspace.

According to one embodiment, the real image 612 may not contain location information associated with the characters. Therefore, in an input prompt (or command) 630, the location information (coordinate tokens) associated with the real image 612 may be replaced with mask tokens [MASK]. A mask token may be a special identifier, such as [MASK], used to intentionally hide a portion of the input data during model training, which serves to teach the model to predict the original, hidden information based on its surrounding context.) In addition, the loss related to the predicted location information (coordinate tokens) for the real image 612 may also be masked.

The deep learning model training unit 330 may compute a first loss function that maximizes the probability of predicting the character information contained in the real image 612 and the probability of predicting the character information contained in the synthetic image 614 and its associated location information. As a concrete example, the first loss function may be computed according to Equation 2 below:

$${L}_{token - O T O R} = - {\sum }_{i = 1}^{N} {w}_{i} log P ( {y}_{i} \vert x , {\hat{y}}_{1 : i - 1} ) \qquad [ Equation 2 ]$$

where wᵢ denotes a pre-assigned weight for coordinate tokens in the token sequence 640. For example, wᵢ=0 may be assigned for the coordinate tokens predicted for the real image, and wᵢ=1 may be assigned for the coordinate tokens predicted for the synthetic image.

Additionally, the deep learning model training unit 330 may compute a second loss function representing a character-wise supervised contrastive loss, based on the real image 612 and the synthetic image 614. As a concrete example, the second loss function may be computed for all characters included in a batch by Equation 3 below:

$${L}_{SupCon} = {\sum }_{j ∈ C} \frac{- 1}{\vert P ( j ) \vert} {\sum }_{p ∈ P ( j )} log \frac{exp ( {z}_{j} \cdot {z}_{p} / τ )}{{\sum }_{a ∈ A ( j )} exp ( {z}_{j} \cdot {z}_{a} / τ )} \qquad [ Equation 3 ]$$

where C denotes the set of all characters contained in the real image and the synthetic image, j∈C denotes the index of a character, A(j)=C\{j}, P(j)={p ∈A(j): cₚ=cⱼ} is the set of indices that have the same character label c, |P(j)| denotes the cardinality of P(j), symbol · denotes a dot product, and τ denotes a scalar temperature.

The deep learning model training unit 330 may compute a total loss function and train the deep learning model 620 by minimizing this total loss function.

The total loss function may be computed based on the first loss function and/or the second loss function. As a concrete example, the total loss function may be computed by Equation 4 below:

$$L = \frac{1}{M} {\sum }_{m = 1}^{M} {L}_{token - O T O R}^{m} + λ {L}_{SupCon} \qquad [ Equation 4 ]$$

where M is the number of image-label pairs, and λ denotes a scaling factor of L_{SupCon}.

As described above, the trained deep learning model 620 may predict a token sequence including character information (character tokens) contained in the input image and location information (coordinate tokens) associated with the character information. As described above, the trained deep learning model 620 may be fine-tuned to perform various downstream tasks from the input image, in response to various user prompts indicating the type of operation.

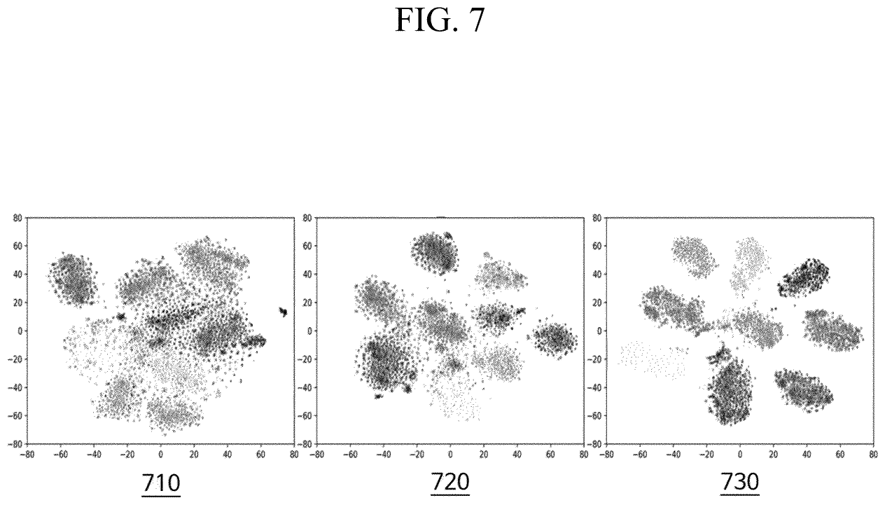

FIG. 7 is a diagram illustrating examples of feature clustering results from a deep learning model trained by various training methods. The feature clustering results from the deep learning model shown in FIG. 7 are calculated by mapping high-dimensional features extracted from the final layer of the decoder of the deep learning model into a low-dimensional space using the t-distributed Stochastic Neighbor Embedding (t-SNE) method. A first example 710 shows a feature clustering result from a baseline deep learning model, a second example 720 shows a feature clustering result from a character-wise supervised contrastive learning model, and a third example 730 shows a feature clustering result from a character-wise supervised contrastive learning model trained using training data including a synthetic character images and a real character image.

It can be observed that the features extracted from each character become more distinct, increasingly from the first example 710 to the third example 730. That is, when using a character-wise supervised contrastive learning model according to the present invention, it is possible to extract more distinct character features compared to the conventional art. Furthermore, by additionally using a synthetic image through rendering according to the present invention, the accuracy of character recognition can be further improved.

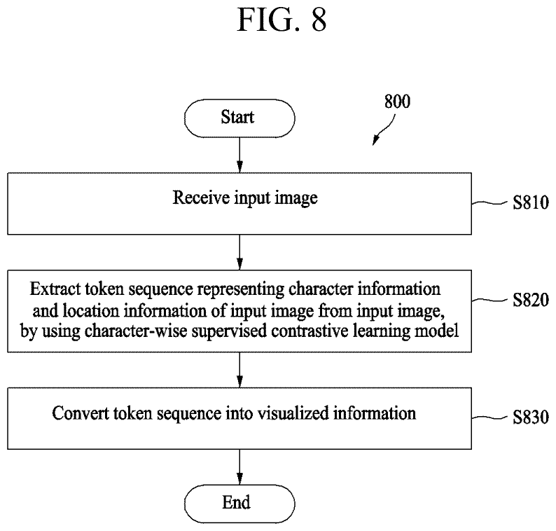

FIG. 8 is a flowchart illustrating an example of an OCR method 800 using a character-wise supervised contrastive learning model corresponding to the deep learning model 130, according to an embodiment of the present invention. The OCR method 800 using the character-wise supervised contrastive learning model may be performed by the processor 220 of the computing device 200.

First, the processor 220 may receive an input image (S810). Here, the input image may include a document image and/or a scene image containing characters.

Next, the processor 220 may extract a token sequence representing character information and location information of the input image from the input image, by using a character-wise supervised contrastive learning model 130 (S820). According to one embodiment, the token sequence may be extracted from the input image in response to a user prompt, by the character-wise supervised contrastive learning model 130.

For example, the processor 220 may extract embeddings from the input image by the deep learning-based encoder of the character-wise supervised contrastive learning model 130 and extract a token sequence from the embeddings by the deep learning-based decoder of the character-wise supervised contrastive learning model 130. In one embodiment, the deep learning-based encoder may be either a convolutional neural network (CNN)-based model or a Transformer-based model. Additionally, in one embodiment, the deep learning-based decoder may include either a Bidirectional and Auto-Regressive Transformers (BART)-based decoder or an auto-regressive decoder.

According to one embodiment, the character-wise supervised contrastive learning model 130 may be a model trained to output a token sequence representing character information and location information for the input image, by using first training data including a first image and first character information, and second training data including a second image, second character information corresponding to the first character information, and location information associated with the second character information.

Additionally, the processor 220 may convert the token sequence into visualized information (S830). For example, the visualized information may include a layer added on top of the input image, including character information and/or location information (e.g., a bounding box) corresponding to the character information.

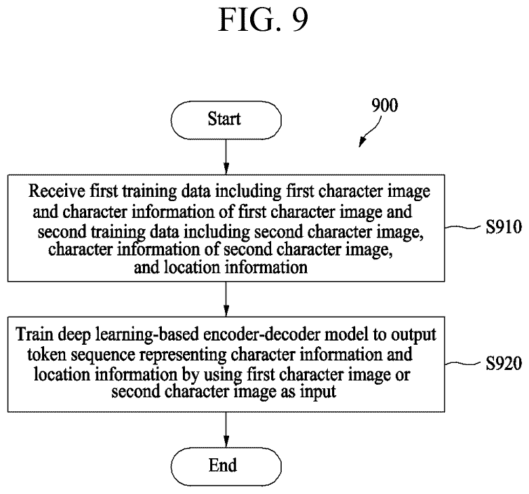

FIG. 9 is a flowchart illustrating an example of a character-wise supervised contrastive learning method 900 for OCR according to an embodiment of the present invention. The character-wise supervised contrastive learning method 900 for OCR may be performed by a the processor 220 of the computing device 200.

The processor 220 may receive first training data including a first image and first character information. Additionally, the processor 220 may receive second training data including a second image, second character information corresponding to the first character information, and location information associated with the second character information (S910). According to one embodiment, the second image may be generated based on the first character information, font information, and image background information.

Then, the processor 220 may train a deep learning-based encoder-decoder model to output a token sequence representing character information and location information for the input image, by using the first training data and the second training data (S920).

For example, the processor 220 may train the deep learning-based encoder-decoder model by using a first loss function that maximizes the probability of predicting the first character information by using the first image as an input and the probability of predicting the second character information and location information associated with the second character information by using the second image as an input.

Additionally or alternatively, the processor 220 may train the deep learning-based encoder-decoder model by using a second loss function that computes a character-wise supervised contrastive loss based on the first training data and the second training data.

According to one embodiment, the deep learning-based encoder-decoder model may be further trained to output a token sequence in response to a user prompt. In this case, the first training data and the second training data each may further include a user prompt indicating the type of an OCR operation.

The flowcharts illustrated in FIGS. 8 and 9 and the foregoing descriptions are merely examples and may be implemented differently in some examples. For example, in some embodiments, the order of the steps may be changed, some steps may be repeatedly performed, some steps may be omitted, and some steps may be added.

The above-described method may be provided as a computer program stored in a computer-readable recording medium for execution on a computer. The medium may be a type of medium that continuously stores a program executable on a computer, or temporarily stores the program for execution or download. In addition, the medium may be a variety of recording means or storage means in the form of a single piece of hardware or a combination of several pieces of hardware, and is not limited to a medium that is directly connected to any computer system, and accordingly, may be present on a network in a distributed manner. An example of the medium may include a medium configured to store program instructions, including a magnetic medium such as a hard disk, a floppy disk, and a magnetic tape, an optical medium such as a CD-ROM and a DVD, a magneto-optical medium such as a floptical disk, ROM, RAM, and flash memory. In addition, other examples of the medium may include recording or storage media managed by app stores that distribute applications, or by sites or servers that supply or distribute various other software.

The methods, operations, or techniques of the present invention may be implemented by various means. For example, these techniques may be implemented in hardware, firmware, software, or a combination thereof. Those skilled in the art will appreciate that various illustrative logical blocks, modules, circuits, and algorithm steps described in connection with the invention herein may be implemented in electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software varies depending on design requirements imposed on the particular application and the overall system. Those skilled in the art may implement the described functionality in various ways for each particular application, but such implementations should not be construed as causing a departure from the scope of the present invention.

In a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, a computer, or a combination thereof.

Accordingly, the various illustrative logical blocks, modules, and circuits described in connection with the present invention may be implemented or performed by any combination of a processor, a DSP, an ASIC, an FPGA or other programmable logic device, discrete gate or transistor logic, discrete hardware components, or those designed to perform the functions described herein. A processor may be a microprocessor, but in the alternative, a processor may be any controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In firmware and/or software implementation, the invention may be implemented as instructions stored in a computer-readable medium such as random access memory (RAM), read-only memory (ROM), non-volatile random access memory (NVRAM), programmable read-only memory (PROM), erasable programmable read-only memory (EPROM), electrically erasable PROM (EEPROM), flash memory, a compact disc (CD), or a magnetic or optical data storage device. The instructions may be executable by one or more processors, and may cause the processor(s) to perform certain aspects of the functionality described in the present disclosure.

When implemented in software, the invention may be stored on a computer-readable medium as one or more instructions or codes, or may be transmitted through a computer-readable medium. The computer-readable media include both the computer storage media and the communication media including any medium that facilitates the transmission of a computer program from one place to another. Storage media may also be any available media that may be accessible by a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessible by a computer. In addition, random access may be suitably made to computer-readable media.

For example, if software is transmitted from a website, server, or other remote source by using a coaxial cable, a fiber optic cable, a twisted pair cable, a digital subscriber line (DSL), or wireless technologies such as infrared ray, radio, and microwave, then the coaxial cable, fiberoptic cable, twisted pair cable, digital subscriber line, or wireless technologies such as infrared ray, radio, and microwave may be included in the definition of media. As used herein, disks and discs include CD, laser disc, optical disc, digital versatile disc (DVD), floppy disk, and Blu-ray disc, where disks usually reproduce data magnetically, whereas discs reproduce data optically using lasers. Combinations of the above should also be included in the scope of computer-readable media.

Software modules may be configured to reside in RAM memory, flash memory, ROM memory, EPROM memory, EEPROM memory, registers, a hard disk, a removable disk, a CD-ROM, or any other form of storage medium. An exemplary storage medium may be coupled to a processor so that the processor may read information from or write information to the storage medium. Alternatively, the storage medium may be integrated into a processor. The processor and the storage medium may be present within an ASIC. The ASIC may be present in a user terminal. Alternatively, the processor and the storage medium may be present as separate components in the user terminal.

Although the above-described embodiments have been described as utilizing aspects of the subject matter disclosed herein on one or more standalone computer systems, the invention is not limited thereto and may also be implemented in conjunction with any computing environment such as a network or distributed computing environment. Furthermore, aspects of the subject matter of this invention may be implemented in multiple processing chips or devices, and storage may be similarly effected across the multiple devices. These devices may include PCs, network servers, and portable devices.

Although the present invention has been described in relation to some embodiments in this specification, various modifications and changes may be made without departing from the scope of the present invention as can be understood by those skilled in the art to which the invention pertains. In addition, such modifications and changes should be considered to fall within the scope of the claims attached herein.

1. An OCR method using a character-wise supervised contrastive learning model, which is performed by at least one processor of a computing device, the OCR method comprising the steps of:
receiving an input image;
extracting, from the input image, a token sequence representing character information and location information of the input image from a character-wise supervised contrastive learning model; and
converting the token sequence into visualized information.

2. The OCR method of claim 1, wherein the token sequence is extracted from the input image in response to a user prompt input in the character-wise supervised contrastive learning model.

3. The OCR method of claim 1, wherein the step of extracting the token sequence includes the steps of:
extracting embeddings from the input image by a deep learning-based encoder; and
extracting the token sequence from the embeddings by a deep learning-based decoder.

4. The OCR method of claim 1, wherein the character-wise supervised contrastive learning model is trained to output the token sequence by using first training data including a first image and first character information, and second training data including a second image, second character information corresponding to the first character information, and location information associated with the second character information.

5. A character-wise supervised contrastive learning method for OCR, which is performed by at least one processor of a computing device, the method comprising the steps of:
receiving first training data including a first image and first character information;
receiving second training data including a second image, second character information corresponding to the first character information, and location information associated with the second character information; and
training a deep learning-based encoder-decoder model to output a token sequence representing character information and location information for an input image, by using the first training data and the second training data.

6. The character-wise supervised contrastive learning method of claim 5, wherein the first training data and the second training data each further includes a user prompt indicating a type of an OCR operation.

7. The character-wise supervised contrastive learning method of claim 5, wherein the second image is generated based on the first character information, font information, and image background information.

8. The character-wise supervised contrastive learning method of claim 5, wherein the deep learning-based encoder-decoder model is trained by using a first loss function that maximizes a probability of predicting the first character information by using the first image as an input and a probability of predicting the second character information and the location information associated with the second character information by using the second image as an input.

9. The character-wise supervised contrastive learning method of claim 5, wherein the deep learning-based encoder-decoder model is trained by using a second loss function for computing a character-wise supervised contrastive loss based on the first training data and the second training data.

10. A non-transitory computer-readable recording medium having instructions recorded thereon for executing the OCR method of claim 1 on a computer.

11. An OCR system using a character-wise supervised contrastive learning model, comprising:
a memory; and
at least one processor connected to the memory, and configured to run at least one computer-readable program included in the memory,
wherein the at least one processor receives an input image, extracts, from the input image, a token sequence representing character information and location information of the input image from a character-wise supervised contrastive learning model, and includes one or more instructions for converting the token sequence into visualized information.
